(19) United States
(12) Patent Application Publication
(10) Pub. No.: US 2025/0183929 A1
(43) Pub. Date: Jun. 5, 2025

(54) METHOD AND APPARATUS FOR INTERFERENCE CANCELLATION BASED RECEPTION FOR SINGLE USER AND MULTI-USER SCENARIOS

(71) Applicant: Indian Institute of Technology Kharagpur, Kharagpur (IN)

(72) Inventors: B.V. Sudhakar Reddy, Kharagpur (IN); Chaithanya Velampalli, Kharagpur (IN); Suvra Sekhar Das, Kharagpur (IN)

(21) Appl. No.: 18/610,712

(22) Filed: Mar. 20, 2024

(30) Foreign Application Priority Data
Dec. 2, 2023 (IN) 202331082160

(51) Int. Cl. H04B 1/10; H04L 25/03; H04L 27/34

(52) U.S. Cl. CPC H04B 1/1027; H04L 25/03159; H04L 27/34

(57) ABSTRACT

Provided is a method and apparatus for interference cancellation in wireless signals received from a user equipment and a plurality of user equipment. The method (400) for interference cancellation in wireless signal efficiently recovers transmitted signal from received wireless signals. The method (400) comprises identifying (402) one or more Correctly decoded Code Blocks (CCBs) and one or more Wrongly decoded Code Blocks (WCBs) in received wireless signal. Further, the method comprises reconstructing (404) transmitted signal in each iteration based on the one or more CCBs identified up to previous iteration. Furthermore, the method comprises determining (406), using an initial channel matrix, a corresponding channel matrix in each iteration. The method comprises cancelling (408) the interference in each iteration on the one or more WCBs and thereby performing (410) a channel equalization on interference free received wireless signal using the corresponding channel matrix (H^{(q)}) to form interference free transmitted signal.

### CROSS REFERENCE

This non-provisional convention application claims priority of Indian Patent Application No. 202331082160, filed on Dec. 2, 2023, and hereby claims the benefit of the embodiments therein and of the filing date thereof.

### FIELD OF INVENTION

The present disclosure relates to wireless communication. Particularly, but not exclusively, the present disclosure is directed toward a method and apparatus for interference cancellation in wireless signals received from single user and multi-users scenarios.

### BACKGROUND OF THE INVENTION

An ongoing progress in wireless technology is essential to meet the increasing need for faster data rates, reduced latency, and improved connectivity for users. Over the years, wireless waveforms have evolved from second generation (2G) to fifth generation (5G) in response to the advancements in the digital sector. Furthermore, development of sixth generation (6G) is currently underway to deliver even higher data rates and lower latency, catering to the requirements of autonomous vehicles, intelligent transportation systems, Internet of Things (IoT) devices, and advanced healthcare, among other applications.

Various wireless waveforms have been proposed to meet the requirement of 2G to 6G wireless technologies. Among various wireless waveforms, notably, an Orthogonal Frequency Division Multiplexing (OFDM) waveform has been adopted in 4G. Further, a variant of OFDM is used in 5G. Furthermore, a new waveform Orthogonal Time Frequency Space (OTFS) has been invented for high mobility and reliability in 5G and 6G wireless networks. The conventional arts fail to disclose efficient receivers for multiple access (MA) schemes for multiple users in the OTFS waveform.

In accordance with a non-patent literature (S. S. Das et. al, “Performance of iterative Successive interference cancellation receiver for LDPC coded OTFS,” 2020 IEEE ANTS 2020), a Forward Error Correction (FEC) based Successive Interference Cancellation (SIC) receiver is disclosed. The FEC-based SIC receiver is designed for Orthogonal Time Frequency Space (OTFS) waveform. Further, the receiver is used for single user only. Moreover, a channel matrix used for equalization in each SIC iteration remains fixed, and the same channel equalization is applied to each interference-free signal of each iteration. In each SIC iteration, the interference-free signal incorporates varying channel effects. Same channel matrix used in each SIC iteration generates high errors during canceling the interference. Further, the said FEC based SIC receiver fails to process data received from a plurality of users.

In accordance with another non-patent literature (T Thaj et. al. “Orthogonal Time Sequency Multiplexing Modulation: Analysis and Low-Complexity Receiver Design,” IEEE WCNC-2021, pp. 1-7, 2021), turbo receiver for time domain signal processing is provided. The prior art supports only single user scenarios. T. Thaj et. al. fail to disclose time domain signal processing for multiple users.

In accordance with yet another non-patent literature (Rose Mary Augustine et al. “Interleaved Time-Frequency Multiple Access Using OTFS Modulation,” IEEE VTC (VTC2019-Fall), pp 1-5, 2019), multiuser receivers for OTFS based on ideal transmit and receive pulse shapes are mentioned. However, such receivers fail to work with practical pulse shapes, which are used in practice.

In accordance with yet another non-patent literature, (O. K. Rasheed et al. “Sparse Delay-Doppler Channel Estimation in Rapidly Time-Varying Channels for Multiuser OTFS on the Up-link,” IEEE VTC-2020 (VTC2020-Spring), pp. 1-5, 2020), MMSE based multi-user receivers for OTFS is mentioned. However, O. K. Rasheed et al. recite the multi-user receivers by considering only ideal pulse shapes of signals. However, in real scenario, the pulse shapes may vary based on interference and noises in channels.

In accordance with a patent literature U.S. Pat. No. 8,949,683B1, an FEC-based SIC receiver is disclosed. However, the said patent literature fails to address perform channel equalization for each of the SIC iterations. Further, the patent literature U.S. Pat. No. 8,949,683B1 fails to describe handling multiple users by the FEC-based SIC receiver.

In accordance with another patent literature U.S. Ser. No. 10/484,210B2, an FEC-based SIC receiver is disclosed. However, the FEC-based SIC receiver sequentially decodes the user data which may require more time to process received signals.

FIG. 1 illustrates a schematic circuit diagram of a Successive Interference Cancellation (SIC) based receiver with fixed channel equalization with matrix H, in accordance with an existing art. As shown in FIG. 1, the SIC-based receiver receives signal y, and thereby performs channel equalization with matrix H. The SIC-based receiver performs demodulation, low-density parity-check (LDPC) decoding, and reconstruction of originally transmitted signals. However, in each iteration, the SIC-based receiver performs channel equalization with same matrix H.

FIG. 2 illustrates a schematic circuit diagram of a turbo receiver i, in accordance with an existing art.

As shown in FIG. 2, the turbo receiver receives the signal from a single user and thereby performs interference cancellation in the received signal in an iterative manner and number of iterations is limited by a maximum of Q. Q may be any natural number. A Gauss-Seidel (GS) based iterative detector receives signal y and a matrix H. The output of GS detector is thereby demodulated, deinterleaved, channel decoded, interleaved, and remodulated. A method for processing multi-user received signals is not disclosed in the current state of the art.

Therefore, there is a need for a method and apparatus for interference cancellation-based reception for multi-user scenarios, that is also applicable for single user scenario. The present disclosure is directed to overcome one or more limitations stated above, and any other limitation associated with the prior arts.

### SUMMARY OF INVENTION

One or more shortcomings of the prior art are overcome, and additional advantages are provided through the present disclosure. Additional features and advantages are realized through the techniques of the present disclosure. Other embodiments and aspects of the disclosure are described in detail herein and are considered a part of the claimed disclosure.

According to one or more embodiments, the present disclosure relates to a method for interference cancellation in wireless signal received from a user equipment operating by a single user. The method comprises identifying one or more Correctly decoded Code Blocks (CCBs) and one or more Wrongly decoded Code Blocks (WCBs) by preprocessing the received wireless signal. Further, the method comprises reconstructing transmitted signal in each iteration by Quadrature Amplitude Modulation (QAM) followed by a waveform modulation. The transmitted signal is reconstructed based on the one or more CCBs identified from the received wireless signal up to previous iteration. However, corresponding positions of the one or more WCBs of the received wireless signal are assigned with zero values. The method further comprises determining a corresponding channel matrix in each iteration using an initial channel matrix based on the positions of zero or non-zero values in the reconstructed transmitted signals. Subsequently, the method comprises cancelling the interference in each iteration on the one or more WCBs that form a part of the received wireless signal. The interference is caused by corresponding one or more CCBs which form a part of the received wireless signal. Upon cancelling the interference, the method comprises performing a channel equalization on the interference free received wireless signal by a channel equalization technique using the corresponding channel matrix. The channel equalization results in one or more CCBs from the one or more WCBs identified in the earlier iteration.

According to one or more embodiments, the method comprises demodulating the channel equalized wireless signals to extract signal information of the one or more WCBs identified in previous iteration. Further, the method comprises decoding each bit of the demodulated wireless signals of the one or more WCBs identified in the previous iteration by a Low-Density Parity-Check (LDPC) decoder. Furthermore, the method comprises identifying the one or more CCBs and the one or more WCBs from the decoded wireless signals for subsequent iterations.

According to one or more embodiments, the one or more CCBs and the one or more WCBs are identified by preprocessing the received wireless signal for an initial iteration only. In preprocessing the received wireless signal, the method comprises performing, by the channel equalization technique, the channel equalization on the received wireless signal to compensate distortion of the transmitted signals that are being transmitted by the user equipment. Thereby, the method comprises demodulating the channel equalized wireless signals to extract original signal information of the transmitted signals. Further, the method comprises decoding, by a Low-Density Parity-Check (LDPC) decoder, each bit of the demodulated wireless signals for determining code blocks of the transmitted signals. Upon decoding each bit of the demodulated wireless signals, the method comprises identifying the one or more CCBs and the one or more WCBs from the determined code blocks.

According to one or more embodiments, the method of demodulating the channel equalized wireless signals further comprises performing a waveform demodulation on the received wireless signal. Upon performing the waveform demodulation, the method comprises estimating Log Likelihood Ratio (LLR) values of the demodulated received wireless signal by a soft demodulation. Thereafter, the method comprises forming code blocks for LDPC decoding by the LDPC decoder based on the estimated LLR values.

According to one or more embodiments, the one or more CCBs and the one or more WCBS are identified using a Cyclic Redundancy Check (CRC) process after the LDPC decoding.

According to one or more embodiments, the method of cancelling the interference on the one or more WCBs further comprises reconstructing originally transmitted signal. The originally transmitted signals are reconstructed using the CCBs identified from the received wireless signal up to the previous iteration. During reconstruction, zeros are assigned to corresponding positions of the modulation symbols of the WCBs. Upon reconstructing the originally transmitted signal, the method comprises processing the reconstructed transmitted signal by multiplying the initial channel matrix with the reconstructed transmitted signals. Thereafter, the method comprises subtracting the processed reconstructed transmitted signals from the received wireless signal to cancel the interference on the one or more WCBs.

According to one or more embodiments, the corresponding channel matrix is updated in each iteration based on the zero or non-zero values in the reconstructed transmitted signals. Further, the corresponding channel matrix is updated by nullifying column vectors of the corresponding channel matrix using zero vectors relating to indices of the non-zero values in the reconstructed wireless signals. The non-zero values exist over corresponding positions of the one or more CCBs in the reconstructed transmitted signals.

According to one or more embodiments, the identification of the one or more CCBs and the one or more WCBs is continued until either a threshold number of iterations is reached or all code blocks of the received wireless signal relate to the one or more CCBs.

According to one or more embodiments, the present disclosure relates to a method for cancelling interference in received wireless signals from a plurality of user equipment. The method comprises identifying one or more Correctly decoded Code Blocks (CCBs) and one or more Wrongly decoded Coded Blocks (WCBs) in the wireless signals received from each of the plurality of user equipment. The one or more CCBs and the one or more WCBs are identified by preprocessing the received wireless signals. Thereafter, the method comprises reconstructing transmitted signals from the plurality of user equipment by Quadrature Amplitude Modulation (QAM) followed by a waveform modulation in each iteration. The transmitted signals are reconstructed by combining the one or more CCBs identified from the received wireless signal up to previous iteration from each of the plurality of user equipment. During reconstruction, zero values are assigned to corresponding positions of the one or more WCBs. The method further comprises determining a corresponding effective channel matrix using an initial effective channel matrix in each iteration based on the positions of zero or non-zero values in the combination of the reconstructed transmitted signals. Thereby, the method comprises cancelling the interference on the one or more WCBs that form a part of the received wireless signal in each iteration. The interference is caused by corresponding one or more CCBs which form a part of the received wireless signal. Further, the method comprises performing a channel equalization on interference free received wireless signals by a channel equalization technique using the corresponding channel matrix. Upon channel equalization, the method comprises forming the one or more CCBs from the one or more WCBs identified in earlier iteration.

According to one or more embodiments, the method further comprises decoupling the channel equalized wireless signals to identify received wireless signals from each of the plurality of user equipment. Thereby, the method comprises demodulating the decoupled wireless signals from each of the plurality of user equipment to extract signal information of the one or more WCBs identified in the previous iteration. The channel equalized one or more CCBs relates to a part of the transmitted signals from each of the plurality of user equipment. Subsequently, the method comprises decoding, by a Low-Density Parity-Check (LDPC) decoder for each of the plurality of user equipment, each bit of the demodulated wireless signals of the one or more WCBs identified in the previous iteration. Further, the method comprises identifying the one or more CCBs and the one or more WCBs from the decoded wireless signals received from each of the plurality of user equipment for subsequent iterations.

According to one or more embodiments, the one or more CCBs and the one or more WCBs further are identified by preprocessing the received wireless signals from the plurality of user equipment for an initial iteration only. In preprocessing the received wireless signals, the method comprises performing the channel equalization on the received wireless signals by the channel equalization technique. The channel equalization is performed to compensate distortion of transmitted signals that are being transmitted by the plurality of user equipment. Further, the method comprises decoupling the channel equalized received wireless signals to identify received wireless signals from each of the plurality of user equipment. Thereby, the method comprises demodulating the received wireless signals of each of the plurality of user equipment to extract original signal information of the transmitted signals. Further, the method comprises decoding, by a Low-Density Parity-Check (LDPC) decoder, each bit of the demodulated wireless signals of each of the plurality of user equipment for determining code blocks of the transmitted signals. Subsequently, the method comprises identifying the one or more CCBs and the one or more WCBs from the determined code blocks of each of the plurality of user equipment.

According to one or more embodiments, the method of demodulating the received wireless signals of each of the plurality of user equipment further comprises performing a waveform demodulation on the received wireless signals of each of the plurality of user equipment. The method further comprises estimating, by a soft demodulation, Log Likelihood Ratio (LLR) values of the demodulated received wireless signals of each of the plurality of user equipment. Thereby, the method comprises forming, based on the estimated LLR values, code blocks for LDPC decoding by the LDPC decoder.

According to one or more embodiments, the corresponding effective channel matrix is updated in each iteration based on the zero or non-zero values in the reconstructed transmitted signals from the plurality of user equipment. Further, the corresponding effective channel matrix is updated by nullifying column vectors of the corresponding channel matrix using zero vectors relating to indices of the non-zero values in the reconstructed wireless signals from the plurality of user equipment. The non-zero values exist over corresponding positions of the one or more CCBs in the reconstructed transmitted signals.

According to one or more embodiments, the present disclosure relates to an apparatus of Forward Error Correction (FEC) based Successive Interference Cancellation (SIC) receiver for cancelling interference in wireless signal received from a user equipment. The apparatus comprises one or more antennas configured for receiving analog wireless signal from a transmitter of the user equipment. The method further comprises an analog-to-digital converter (ADC) device for converting analog wireless signals to corresponding digital signals. Furthermore, the method comprises one or more processors communicatively coupled with the one or more antennas and the ADC device. The one or more processors are configured to identify one or more Correctly decoded Code Blocks (CCBs) and one or more Wrongly decoded Code Blocks (WCBs) by preprocessing the digital signals of the received wireless signal. Thereby, the one or more processors are configured to reconstruct, by Quadrature Amplitude Modulation (QAM) followed by a waveform modulation, transmitted signal in each iteration. The transmitted signal is reconstructed based on the one or more CCBs identified from the received wireless signal up to previous iteration.

During reconstruction, zero values are assigned to corresponding positions of the one or more WCBs. Further, the one or more processors are configured to determine, using an initial channel matrix, a corresponding channel matrix in each iteration based on the positions of zero or non-zero values in the reconstructed transmitted signals. Thereby, the one or more processors are configured to cancel the interference in each iteration on the one or more WCBs that form a part of the received wireless signal. The interference is caused by corresponding one or more CCBs which form a part of the received wireless signal. Upon cancelling the interference, the one or more processors are configured to perform a channel equalization on interference free received wireless signal by a channel equalization technique using the corresponding channel matrix. The channel equalization is performed to form the one or more CCBs from the one or more WCBs identified in earlier iteration.

According to one or more embodiments, the present disclosure relates to an apparatus of Forward Error Correction (FEC) based Successive Interference Cancellation (SIC) receiver for cancelling interference in wireless signals received from a plurality of user equipment. The apparatus comprises one or more antennas configured for receiving analog wireless signal from one or more transmitters corresponding to the plurality of user equipment. The apparatus further comprises a plurality of analog-to-digital converter (ADC) devices for converting analog wireless signals to corresponding digital signals. Furthermore, the apparatus comprises one or more processors communicatively coupled with the one or more antennas and the plurality of ADC devices. The one or more processors are configured to identify, by preprocessing the received wireless signals, one or more Correctly decoded Code Blocks (CCBs) and one or more Wrongly decoded Coded Blocks (WCBs) in the wireless signals received from each of the plurality of user equipment. Thereby, the one or more processors are configured to reconstruct, by Quadrature Amplitude Modulation (QAM) followed by a waveform modulation in each iteration, transmitted signals from the plurality of user equipment. The transmitted signals are reconstructed by combining the one or more CCBs identified from the received wireless signal up to previous iteration from each of the plurality of user equipment.

During reconstruction, zero values are assigned to corresponding positions of the one or more WCBs. The one or more processors are configured to determine, using an initial effective channel matrix, a corresponding effective channel matrix in each iteration based on the positions of zero or non-zero values in the combination of the reconstructed transmitted signals. Upon determining the corresponding effective channel matrix, the one or more processors are configured to cancel the interference on the one or more WCBs that form a part of the received wireless signal in each iteration. The interference is caused by corresponding one or more CCBs which form a part of the received wireless signal. Subsequently, the one or more processors are configured to perform, by a channel equalization technique using the corresponding channel matrix, a channel equalization on interference free received wireless signals to form the one or more CCBs from the one or more WCBs identified in earlier iteration.

The foregoing summary is illustrative only and is not intended to be in any way limiting. In addition to the illustrative aspects, embodiments, and features described above, further aspects, embodiments, and features will become apparent by reference to the drawings and the following detailed description.

### A BRIEF DESCRIPTION OF THE DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a schematic circuit diagram of a Successive Interference Cancellation (SIC) based receiver with fixed channel equalization with matrix H, in accordance with an existing art;

FIG. 2 illustrates a schematic circuit diagram of a turbo receiver, in accordance with an existing art;

FIG. 3 illustrates a schematic circuit diagram of an apparatus of Forward Error Correction (FEC) based SIC receiver, in accordance with an embodiment of the present disclosure;

FIG. 4A illustrates a flow chart of a method 400 for interference cancellation in wireless signal received from the user equipment, in accordance with an embodiment of the present disclosure;

FIG. 4B illustrates a detailed flow chart of a method step 402 for identifying one or more Correctly decoded Code Blocks (CCBs) and one or more Wrongly decoded Code Blocks (WCBs), in accordance with an embodiment of the present disclosure;

FIG. 5 illustrates a schematic circuit diagram of an apparatus of the FEC based SIC receiver for cancelling interference in wireless signals received from a plurality of user equipment, in accordance with an embodiment of the present disclosure;

FIG. 6A illustrates a flow chart of a method for interference cancellation in wireless signal received from the plurality of user equipment, in accordance with an embodiment of the present disclosure;

FIG. 6B illustrates a detailed flow chart of a method step 602 for identifying the one or more CCBs and the one or more WCBs by preprocessing the received wireless signals from the plurality of user equipment, in accordance with an embodiment of the present disclosure;

FIG. 7 illustrates a schematic circuit diagram of a turbo receiver for receiving wireless signals from the plurality of user equipment, in accordance with an embodiment of the present disclosure;

FIG. 8 illustrates a flow chart of preprocessing of the received wireless signal in the FEC-based SIC receiver and the turbo receiver used for multiple-user scenarios, in accordance with an embodiment of the present disclosure;

FIG. 9 illustrates a graphical representation of uncoded BLER performance of various waveforms for different numbers of users, in accordance with an embodiment of the present disclosure;

FIG. 10 illustrates a graphical representation of coded BLER performance of OTFS waveform with the FEC-based SIC receiver, in accordance with an embodiment of the present disclosure; and

FIG. 11 illustrates a graphical representation of coded BLER performance of OTFS waveform for the turbo receiver 700, in accordance with an embodiment of the present disclosure.

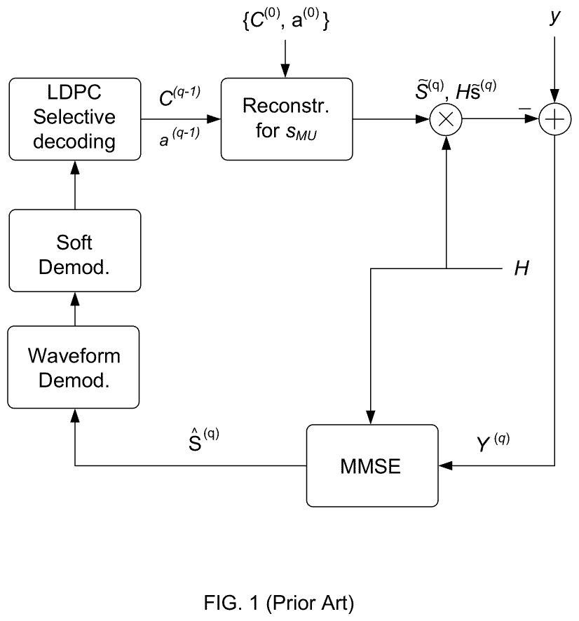

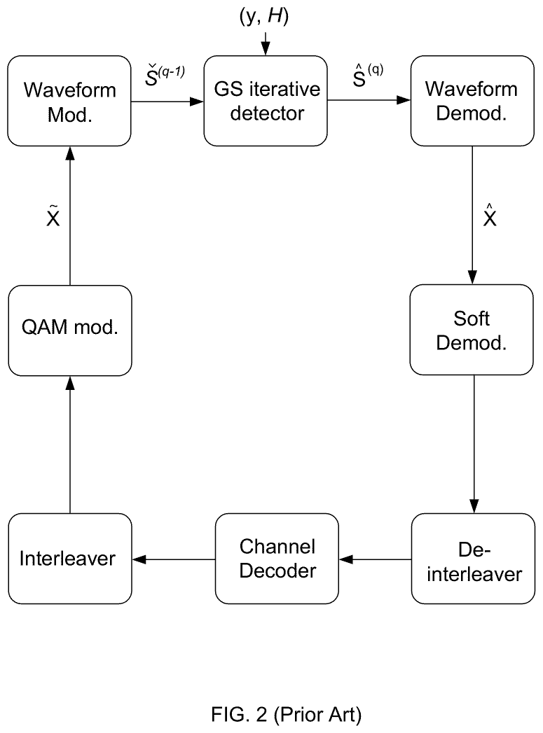

### DETAILED DESCRIPTION OF THE INVENTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that a setup, device, or process that comprises a list of components or steps does not include only those components or steps but may include other components or steps not expressly listed or inherent to such setup or device or process. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and which are shown by way of illustration-specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

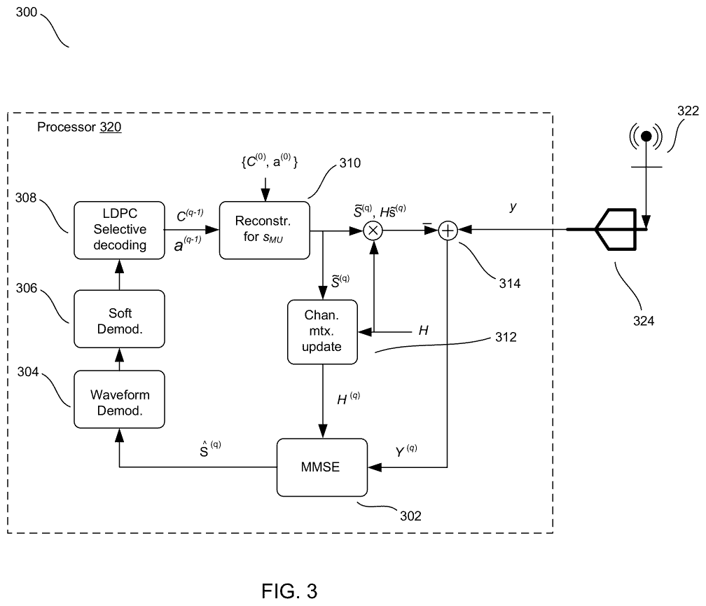

FIG. 3 illustrates a schematic circuit diagram of an apparatus of Forward Error Correction (FEC) based SIC receiver, in accordance with an embodiment of the present disclosure.

As shown in FIG. 3, the FEC-based SIC receiver 300 performs successive interference cancellation in wireless signal iteratively received from a user equipment operating by a single user and number of iterations is limited by a maximum of q, where q may be any natural number. The FEC-based SIC receiver 300 comprises one or more antennas 322, an analog-to-digital converter (ADC) device 324, and at least one processor 320. The one or more antennas 322 are configured for receiving analog wireless signal from a transmitter of the user equipment. The ADC device 324 is configured for converting analog wireless signals to corresponding digital signals. The at least one processor 320 is communicatively coupled with the one or more antennas 322 and the ADC device 324.

The at least one processor 320 of the FEC-based SIC receiver 300 receives digitalized signals y which may be represented by equation (1):

$$y = Hs - w , \qquad ( 1 )$$

where yϵC^{N×1} is the received signal, sϵC^{N×1} is the transmitted signal, HϵC^{N×N} is the channel matrix, and wϵC^{N×1} is the noise vector

According to one or more embodiments, the at least one processor 320 is configured to identify one or more Correctly decoded Code Blocks (CCBs) and one or more Wrongly decoded Code Blocks (WCBs) by preprocessing the digital signals of the received wireless signal y. The one or more CCBs and the one or more WCBs are identified by preprocessing the received wireless signal for an initial iteration only. For preprocessing during the initial iteration only, the at least one processor 320 is configured to perform channel equalization 302 on the received wireless signal y^{(q)} by a channel equalization technique, where y^{(q)} represents the received wireless signal that is being formed in q^{th} iteration. The channel equalization 302 is performed to compensate distortion of transmitted signals that are being transmitted by the transmitter of the user equipment. In a non-limiting example, the channel equalization technique may correspond, but not limited, to Minimum Mean Square Error (MMSE).

Upon performing channel equalization 302 during preprocessing, the at least one processor 320 is configured to demodulate 304, and 306 the channel equalized wireless signals to extract original signal information of the transmitted signals. Thereafter, the at least one processor 320 is configured to decode 308 each bit of the demodulated wireless signals by a Low-Density Parity-Check (LDPC) decoder for determining code blocks of the transmitted signals. Based on the decoding of each bit of the demodulated wireless signals, the at least one processor 320 is configured to identify the one or more CCBs and the one or more WCBs from the determined code blocks. Therefore, during preprocessing at the initial iteration, the at least one processor 320 is configured to identify the one or more CCBs and the one or more WCBs in the transmitted signals. The CCBs represent code blocks that are correctly received via channel during transmission. Alternatively, the one or more WCBs represent code blocks that include interference, noise, corruption, etc. The one or more CCBs and the one or more WCBs are identified using a Cyclic Redundancy Check (CRC) process after the LDPC decoding.

According to one or more embodiments, to demodulate 304, and 306 the channel equalized wireless signals, the at least one processor 320 is configured to perform a waveform demodulation 304 on the received wireless signal. Thereby, the at least one processor 320 is configured to estimate Log Likelihood Ratio (LLR) values of the demodulated received wireless signal by a soft demodulation 306. Upon soft demodulation of the received wireless signal, the at least one processor 320 is configured to form code blocks based on the estimated LLR values for LDPC decoding 308 by the LDPC decoder.

According to one or more embodiments, upon identifying one or more CCBs and one or more WCBs by preprocessing, in a first iteration and subsequent iterations, the at least one processor 320 is configured to reconstruct 310 the transmitted signal. The transmitted signal is reconstructed 310 by Quadrature Amplitude Modulation (QAM) followed by a waveform modulation. The transmitted signal is reconstructed in each iteration based on the one or more CCBs identified from the received wireless signal up to previous iteration. At the initial iteration, reconstructed transmitted signal is being formed from C{C⁽⁰⁾, a⁽⁰⁾}. Thereafter, in q^{th} iteration, the reconstructed transmitted signal s˜^{(q)} is of length N samples being formed based on the one or more CCBs identified in previous iteration, i.e., {C^{(q-1)}, a^{(q-1)}}. Particularly, during reconstruction, the at least one processor 320 is configured to form the reconstructed transmitted signal based on the one or more CCBs identified from interference free received wireless signal. During reconstruction, zero values are assigned to corresponding positions of the one or more WCBs in the reconstructed transmitted signals. Further, the non-zero values exist over corresponding positions of the one or more CCBs in the reconstructed transmitted signals. The indices of positions non-zero values and zero values are stored in a sets A and B respectively, as shown in equations (2), and (3):

$${\tilde{s}}^{( q )} [ n ] = \{ \begin{matrix}s [ n ] & for n ∈ {A}^{( q )} \\ 0 & for n ∈ {B}^{( q )}\end{matrix} , \qquad ( 2 )$$

$${A}^{( q )} ⋃ {B}^{( q )} = \{ 0 , 1 , … , N - 1 \} . \qquad ( 3 )$$

Size of set A^{(q)} (B^{(q)}) in q^{th} iteration increases or decreases with the total number of one or more CCBs obtained from LDPC decoding and CRC check process. The SIC iterations will continue until all the code blocks from the user equipment are turned correct, or a maximum number of iterations is reached, or no new code blocks are decoded correctly in a present iteration. Particularly, the identification of the one or more CCBs and the one or more WCBs is continued until a threshold number of iterations is reached, or all code blocks of the received wireless signal relate to the one or more CCBs.

According to one or more embodiments, in the first iteration and the subsequent iterations, the at least one processor 320 is configured to determine a corresponding channel matrix H^{(q)} in each q^{th} iteration using an initial channel matrix H. The corresponding channel matrix H^{(q)} is updated in each iteration based on the positions of zero or non-zero values in the reconstructed transmitted signals s˜^{(q)}. Thus, the FEC based SIC receiver 300 updates the corresponding channel matrix H^{(q)} in each iteration to improve the channel equalization technique and to cancel interference from the received signal in a more efficient manner than the conventional arts. The corresponding channel matrix H^{(q)} is updated in each iteration based on the zero or non-zero values in the reconstructed transmitted signals. The corresponding channel matrix H^{(q)} is updated by nullifying column vectors of the corresponding channel matrix H^{(q)} using zero vectors relating to indices of the non-zero values in the reconstructed wireless signals. Particularly, the corresponding channel matrix H^{(q)} used for channel equalization in the q^{th} iteration is updated by selecting its column vectors [{hₙ^{(q)}: n=0, 1, . . . , N−1}] as shown in equation (4):

$${h}_{n}^{( q )} = \{ \begin{matrix}{h}_{n} & for n ∈ {B}^{( q )} \\ {0}_{MN} & for n ∈ {A}^{( q )}\end{matrix} , \qquad ( 4 )$$

where hₙ is the n^{th} column vector of the original channel matrix H.

According to one or more embodiments, in the first iteration and the subsequent iterations, the at least one processor 320 is configured to cancel the interference 314 in each q^{th} iteration on the one or more WCBs that form a part of the received wireless signal. The interference is caused by corresponding one or more CCBs which form a part of the received wireless signal. Particularly, the interference on the WCBs is caused by the corresponding one or more CCBs present in the received wireless signals during receiving the wireless signal.

During cancelling the interference 314 on the one or more WCBs, at least one processor 320 is configured to reconstruct originally transmitted signal s˜^{(q)} using the CCBs identified from the received wireless signal up to the previous iteration. The zeros are assigned to corresponding positions of the modulation symbols of the WCBs. The non-zero values exist over corresponding positions of the one or more CCBs in the reconstructed transmitted signals s˜^{(q)}. Further, at least one processor 320 is configured to process the reconstructed transmitted signal s˜^{(q)} by multiplying the initial channel matrix H with the reconstructed transmitted signals s˜^{(q)} to form Hs˜^{(q)}. Thereafter, at least one processor 320 is configured to subtract the processed reconstructed transmitted signals Hs˜^{(q)} from the received wireless signal y to cancel the interference on the one or more WCBs. Upon cancelling the interference 314, the received wireless signal y^{(q)} is formed in q^{th} iteration in which one or more CCBs are increased and one or more WCBs are decreased in each iteration.

According to one or more embodiments, in the first iteration and the subsequent iterations, at least one processor 320 is configured to perform the channel equalization 302 on interference free received wireless signal by the channel equalization technique using the corresponding channel matrix H^{(q)}. The channel equalization 302 on interference free received wireless signal forms the one or more CCBs in q^{th} iteration from the one or more WCBs identified in earlier iteration (q−1)^{th}. In a non-limiting example, the channel equalization technique may correspond, but not limited, to the MMSE.

According to one or more embodiments, in the first iteration and the subsequent iterations, at least one processor 320 is configured to demodulate 304, and 306 the channel equalized wireless signals to extract signal information of the one or more WCBs identified in the previous iteration. The channel equalized one or more CCBs relates to a part of the transmitted signals. Particularly, during demodulation, at least one processor 320 is configured to extract signal information from the one or more WCBs to determine one or more CCBs from the one or more WCBs identified in earlier iteration (q−1)^{th}.

To demodulate 304, and 306 the channel equalized wireless signals ls\hat{ }^{(q)}, the at least one processor 320 is configured to perform the waveform demodulation 304. Further, at least one processor 320 is configured to estimate Log Likelihood Ratio (LLR) values of the demodulated received wireless signal by a soft demodulation 306. Upon soft demodulation of the received wireless signal, the at least one processor 320 is configured to form code blocks based on the estimated LLR values for LDPC decoding 308 by the LDPC decoder.

According to one or more embodiments, in the first iteration and the subsequent iterations, at least one processor 320 is configured to decode 308 each bit of the demodulated wireless signals of the one or more WCBs identified in the previous iteration. The at least one processor 320 is configured to decode 308 each bit by operating the LDPC decoder selectively for decoding one or more WCBs identified in the previous iteration.

According to one or more embodiments, upon decoding 308 by the LDPC decoder, at least one processor 320 is configured to identify the one or more CCBs and the one or more WCBs using the CRC process in each of q^{th} iteration. Furthermore, the at least one processor 320 is configured to reconstruct 310 the transmitted signal in each of q^{th} iteration based on the one or more CCBs that are identified from the received wireless signal up to the previous iteration (q−1)^{th}. The SIC iterations will continue until all the code blocks from the user equipment are turned correct (one or more CCBs), or a maximum number of iterations is reached, or no new code blocks have been decoded correctly in the present iteration.

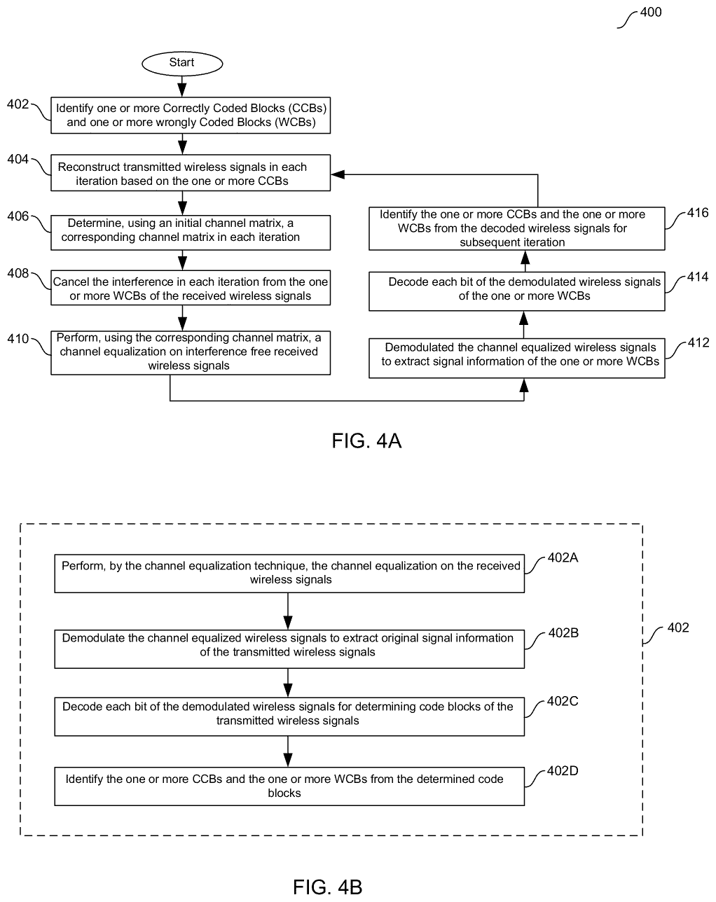

FIG. 4A illustrates a flow chart of a method 400 for interference cancellation in wireless signal received from the user equipment, in accordance with an embodiment of the present disclosure. The method 400 comprises cancelling the interference in the wireless received signal by the FEC-based SIC receiver 300. As depicted in FIG. 4A, the method 400 includes a series of steps 402 through 416 for interference cancellation in the wireless signal. The details of the method 400 have been explained below in forthcoming paragraphs. The order in which the method steps are described below is not intended to be construed as a limitation, and any number of the described method steps can be combined in any appropriate order to execute the method or an alternative method. Additionally, individual steps may be deleted from the method without departing from the spirit and scope of the present disclosure. The method 400 begins from a start block and starts execution of operations at step 402, as shown in FIG. 4A.

At step 402, the method 400 comprises identifying the one or more CCBs and one or more WCBs by preprocessing the received wireless signal. During the preprocessing of the received wireless signal y during the initial iteration only, the at least one processor 320 is configured to identify the one or more CCBs and one or more WCBs. The received wireless signal y may be represented by equation (1) of the present disclosure. The flow of the method 400 now proceeds to step 404.

At step 404, in the first iteration and subsequent iterations, the method 400 comprises reconstructing the transmitted signal in each q^{th} iteration based on the one or more CCBs identified from the received wireless signal up to previous iteration. The at least one processor 320 is configured to reconstruct the transmitted signal in each q^{th} iteration by the QAM followed by the waveform modulation. During reconstruction, the zero values are assigned to corresponding positions of the one or more WCBs. Further, the non-zero values exist over corresponding positions of the one or more CCBs in the reconstructed transmitted signals. The indices of positions non-zero values and zero values are stored in a sets A and B respectively, as shown in equations (2), and (3) in the present disclosure. The flow of the method 400 now proceeds to step 406.

At step 406, the method 400 comprises determining, using the initial channel matrix H, the corresponding channel matrix H^{(q)} in each iteration based on the positions of zero or non-zero values in the reconstructed transmitted signals s˜^{(q)}. The at least one processor 320 is configured to determine the corresponding channel matrix H^{(q)} in each q^{th} iteration. The at least one processor 320 is configured to determine/update the corresponding channel matrix H^{(q)} by nullifying column vectors of the corresponding channel matrix H^{(q)} using zero vectors relating to indices of the non-zero values in the reconstructed wireless signals s˜^{(q)}. The corresponding channel matrix H^{(q)} is determined in each q^{th} iteration as shown in equation (4) of the present disclosure. The flow of the method 400 now proceeds to step 408.

At step 408, the method 400 comprises cancelling the interference in each q^{th} iteration on the one or more WCBs that form a part of the received wireless signal. The interference is caused by corresponding one or more CCBs which form a part of the received wireless signal. Thus, in the first iteration and subsequent iterations, at least one processor 320 is configured to cancel the interference in each q^{th} iteration on the one or more WCBs that form a part of the received wireless signal. The flow of the method 400 now proceeds to step 410.

At step 410, the method 400 comprises performing the channel equalization on interference free received wireless signal by the channel equalization technique using the corresponding channel matrix H^{(q)}. The channel equalization is performed to form the one or more CCBs from the one or more WCBs identified in earlier iteration (q−1)^{th}. The at least one processor 320 is configured to perform the channel equalization by any of the channel equalization techniques. The flow of the method 400 now proceeds to step 412.

At step 412, the method 400 comprises demodulating the channel equalized wireless signals to extract signal information of the one or more WCBs identified in the previous iteration (q−1)^{th}. The channel equalized one or more CCBs represent a part of the transmitted signals. Particularly, the channel equalized one or more CCBs forms the transmitted signals part by part. The at least one processor 320 is configured to demodulate the channel equalized wireless signals to extract signal information of the one or more WCBs. The flow of the method 400 now proceeds to step 414.

Further, at step 414, the method 400 comprises decoding each bit of the demodulated wireless signals of the one or more WCBs identified in the previous iteration by the LDPC decoder. The flow of the method 400 now proceeds to step 416.

At step 416, the method 400 comprises identifying the one or more CCBs and the one or more WCBs from the decoded wireless signals for subsequent iterations. The at least one processor 320 is configured to identify the one or more CCBs and the one or more WCBs using the CRC process in each of q^{th} iteration. The SIC iterations will continue until all the code blocks from the user equipment are turned correct (one or more CCBs), or a maximum number of iterations is reached, or no new code blocks have been decoded correctly in the present iteration.

While the above-discussed steps in FIG. 4A are shown and described in a particular sequence, the steps may occur in variations to the sequence in accordance with various embodiments. Further, a detailed description related to the various steps of FIG. 4A is already covered in the description related to FIG. 3 and is omitted herein for the sake of brevity.

FIG. 4B illustrates a detailed flow chart of a method step 402 for identifying the one or more CCBs and the one or more WCBs, in accordance with an embodiment of the present disclosure. As depicted in FIG. 4B, the method 402 includes a series of steps 402A through 402D for identifying the one or more CCBs and the one or more WCBs. The method step 402 for identifying the one or more CCBs and the one or more WCBs by preprocessing the received wireless signal is performed for the initial iteration only. The method 400 begins execution of operations at step 402A, as shown in FIG. 4B.

At step 402A, the method 402 comprises performing the channel equalization on the received wireless signal to compensate distortion of the transmitted signals that are being transmitted by the transmitter of the user equipment. The at least one processor 320 is configured to perform the channel equalization by any of the channel equalization techniques. The flow of method 402 now proceeds to step 402B.

At step 402B, the method 402 comprises demodulating the channel equalized wireless signals to extract original signal information of the transmitted signals. During demodulation, the method comprises performing the waveform demodulation, and estimating LLR values of the demodulated received wireless signal by the soft demodulation. The flow of method 402 now proceeds to step 402C.

At step 402C, the method 402 comprises decoding each bit of the demodulated wireless signals by the LDPC decoder for determining code blocks of the transmitted signals. Thus, during the initial iteration, at least one processor 320 is configured to decode each bit of the demodulated wireless signals by operating the LDPC decoder. The flow of method 402 now proceeds to step 402D.

At step 402D, the method 402 comprises identifying the one or more CCBs and the one or more WCBs from the determined code blocks. The at least one processor 320 is configured to determine the one or more CCBs and the one or more CCBs for reconstructing the transmitted wireless signals.

While the above-discussed steps in FIG. 4B are shown and described in a particular sequence, the steps may occur in variations to the sequence in accordance with various embodiments. Further, a detailed description related to the various steps of FIG. 4B is already covered in the description related to FIGS. 3-4A and is omitted herein for the sake of brevity.

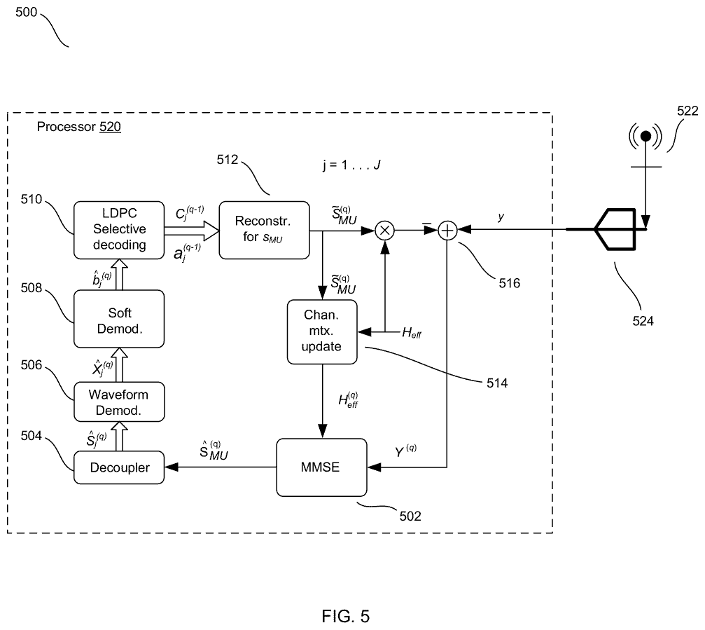

FIG. 5 illustrates a schematic circuit diagram of an apparatus of the FEC based SIC receiver for cancelling interference in wireless signals received from a plurality of user equipment, in accordance with an embodiment of the present disclosure.

As shown in FIG. 5, the FEC-based SIC receiver 500 performs successive interference cancellation in the wireless signals received from a plurality of transmitters corresponding to the plurality of user equipment. The plurality of user equipment may relate to J number of users that transmits signals for an intended reception at a single point. The intended reception or the single point usually relates to a base station or an access point, in which the received signal from J number of users may be shown in:

$$y = {H}_{eff} {s}_{MU} + w , \qquad ( 5 )$$

where H_{eff} is an effective and equivalent channel matrix observed by the receiver for all uplink transmissions, and s_{MU} relates to multi-users transmitted signal represented by equation (6):

$${s}_{MU} = {{\sum }_{j = 1}}^{J} {s}_{j} , \qquad ( 6 )$$

where sⱼ is a transmitted signal from the j^{th} user.

According to one or more embodiments, the FEC-based SIC receiver 500 comprises one or more antennas 522, a plurality of ADC devices 524, and at least one processor 520.

The one or more antennas 522 are configured for receiving analog wireless signal from one or more transmitters corresponding to the plurality of user equipment. The plurality of ADC devices 524 for converting analog wireless signals to corresponding digital signals. The at least one processor 520 is communicatively coupled with the one or more antennas 522 and the plurality of ADC devices 524.

According to one or more embodiments, the at least one processor 520 is communicatively coupled with the one or more antennas 522 and the plurality of ADC devices 524. The at least one processor 520 is configured to identify one or more CCBs and one or more WCBs by preprocessing the received wireless signals from each of the plurality of user equipment for an initial iteration only. During the initial iteration, the at least one processor 520 is configured to perform the channel equalization 502 by the channel equalization technique on the received wireless signals to compensate distortion of transmitted signals that are being transmitted by the plurality of user equipment. In a non-limiting example, the channel equalization may relate, but not limited, to the MMSE. Further, the at least one processor 520 is configured to decouple 504, by operating a decoupler, the channel equalized received wireless signals to identify received wireless signals from each of the plurality of user equipment. Thereby, the at least one processor 520 is configured to demodulate 506, and 508 the received wireless signals of each of the plurality of user equipment to extract original signal information of the transmitted signals. Further, the at least one processor 520 is configured to decode 510, by the LDPC decoder, each bit of the demodulated wireless signals of each of the plurality of user equipment for determining code blocks of the transmitted signals. Further, the at least one processor 520 is configured to identify the one or more CCBs and the one or more WCBs from the determined code blocks of each of the plurality of user equipment. The one or more CCBs and the one or more WCBs are identified by the CRC process after the LDPC decoding

According to one or more embodiments, upon identifying one or more CCBs and one or more WCBs in the initial iteration or subsequent iterations, the at least one processor 520 is configured to reconstruct 512 the transmitted signals from the plurality of user equipment. The transmitted signals are reconstructed 512 by combining the one or more CCBs identified from the received wireless signal up to previous iteration from each of the plurality of user equipment. The transmitted signals are reconstructed 512 by QAM followed by a waveform modulation in each iteration. The zero values are assigned to corresponding positions of the one or more WCBs. The non-zero values exist over corresponding positions of the one or more CCBs in the reconstructed transmitted signals.

Upon reconstructing the transmitted signals, the at least one processor is configured to determine 514, using an initial effective channel matrix H_{eff}, a corresponding effective channel matrix H_{eff}^{(q)} in each of q^{th} iteration based on the positions of zero or non-zero values in the combination of the reconstructed transmitted signals. As the FEC-based SIC receiver 500 receive wireless signals from multiple channels, thus, the effective channel matrix H_{eff} is considered based on channel parameters from the multiple channels.

Further, the at least one processor 520 is configured to cancel 516 the interference on the one or more WCBs that form a part of the received wireless signal in each iteration. The interference is caused by corresponding one or more CCBs which form a part of the received wireless signal y as mentioned in equation 5 of the present disclosure.

Furthermore, the at least one processor 520 is configured to perform 502, by a channel equalization technique using the corresponding channel matrix H_{eff}^{(q)}, a channel equalization on interference free received wireless signals to form the one or more CCBs from the one or more WCBs identified in earlier iteration.

According to one or more embodiments, the at least one processor 520 is configured to decouple 504 the channel equalized wireless signals to identify received wireless signals from each of the plurality of user equipment. Thereafter, the at least one processor 520 is configured to demodulate 506, and 508 the decoupled wireless signals from each of the plurality of user equipment to extract signal information of the one or more WCBs identified in the previous iteration. The channel equalized one or more CCBs relates to a part of the transmitted signals from each of the plurality of user equipment. The at least one processor 520 is configured to decode 510, by the LDPC decoder for each of the plurality of user equipment, each bit of the demodulated wireless signals of the one or more WCBs identified in the previous iteration. Thereby, the at least one processor 520 is configured to identify the one or more CCBs and the one or more WCBs from the decoded wireless signals received from each of the plurality of user equipment for subsequent iterations.

According to one or more embodiments, during demodulating the received wireless signals of each of the plurality of user equipment, the at least one processor 520 is configured to perform the waveform demodulation 506 on the received wireless signals of each of the plurality of user equipment. Thereby, the at least one processor 520 is configured to estimate, by the soft demodulation 508, Log Likelihood Ratio (LLR) values of the demodulated received wireless signals of each of the plurality of user equipment. Upon estimating the estimating LLR values, the at least one processor 520 is configured to form code blocks for LDPC decoding by the LDPC decoder.

According to one or more embodiments, the corresponding effective channel matrix H_{eff}^{(q)} is updated in each iteration based on the zero or non-zero values in the reconstructed transmitted signals from the plurality of user equipment. The corresponding effective channel matrix H_{eff}^{(q)} is updated by nullifying column vectors of the corresponding effective channel matrix H_{eff}^{(q)} using zero vectors relating to indices of the non-zero values in the reconstructed wireless signals from the plurality of user equipment.

The FEC-based SIC receiver 500 of FIG. 5 that receives wireless signals from the plurality of user equipment generally follows the FEC-based SIC receiver 300 as shown FIG. 3 that receives wireless signal from the user equipment. Particularly, the FEC-based SIC receiver 500 works for multi-user scenario. Whereas, the FEC-based SIC receiver 300 works for single user scenario. The FEC-based SIC receiver 500 segregates or decouple the transmitted signal sⱼ of each j^{th} user from the composite received signal s_{MU}. In addition, the FEC-based SIC receiver for multi-user 400 performs user-wise demodulation decoding for each j^{th} user's decoupled channel equalized signal s\hat{ }j^{(q)} from the composite equalized signal s\hat{ }_{MU}^{(q)}. Similarly, for reconstruction, the FEC-based SIC receiver 500 performs user-wise encoding and modulation, and then all users' reconstructed signals are combined to form s\hat{ }_{MU}^{(q)}. For the FEC-based SIC receiver 500, the sets A and B are formed based on s\hat{ }_{MU}^{(q)}, and the channel matrix H_{eff}^{(q)} is updated based on the sets A and B.

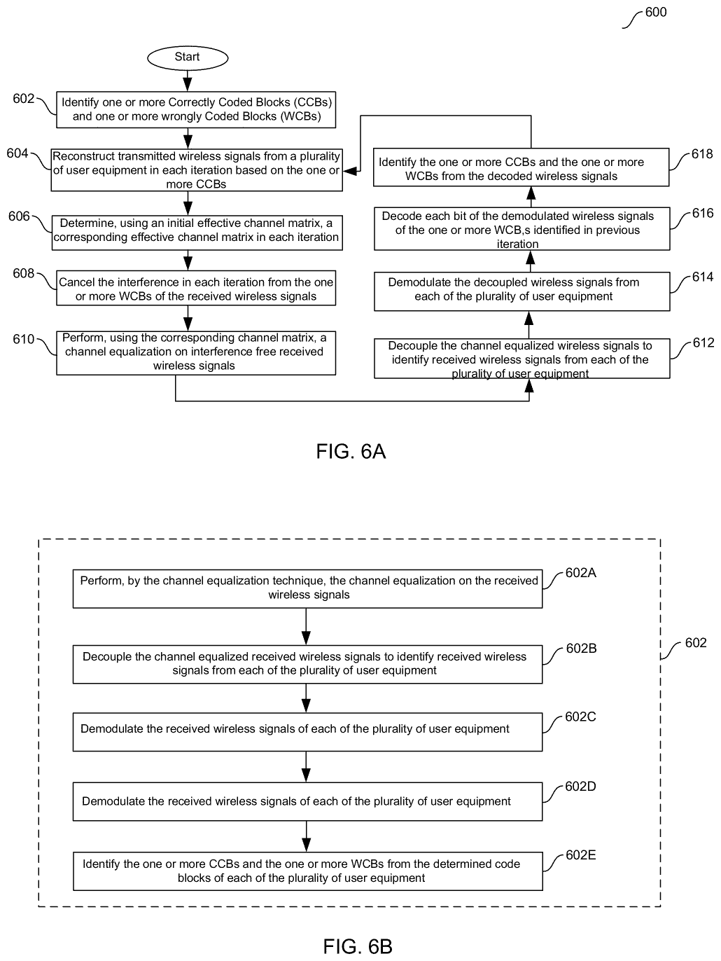

FIG. 6A illustrates a flow chart of a method for interference cancellation in wireless signal received from the plurality of user equipment, in accordance with an embodiment of the present disclosure. The method 600 comprises cancelling the interference in the wireless received signal by the FEC-based SIC receiver 500. As depicted in FIG. 6A, the method 600 includes a series of steps 602 through 618 for interference cancellation in the wireless signal received from the plurality of user equipment. The details of the method 600 have been explained below in forthcoming paragraphs. The order in which the method steps are described below is not intended to be construed as a limitation, and any number of the described method steps can be combined in any appropriate order to execute the method or an alternative method. Additionally, individual steps may be deleted from the method without departing from the spirit and scope of the present disclosure. The method 600 begins from a start block and starts execution of operations at step 602, as shown in FIG. 4A.

At step 602, the method 600 comprises identifying the one or more CCBs and the one or more WCBs in the wireless signals received from each of the plurality of user equipment. The one or more CCBs and the one or more WCBs are identified during the initial iteration only. The flow of the method 600 now proceeds to step 604.

At step 604, in the first iteration and subsequent iterations, the method 600 comprises reconstructing, by the QAM followed by the waveform modulation in each iteration, transmitted signals from the plurality of user equipment by combining the one or more CCBs identified in previous iteration. The flow of the method 600 now proceeds to step 606.

At step 606, the method 600 comprises determining, using the initial effective channel matrix, the corresponding effective channel matrix in each q^{th} iteration based on the positions of zero or non-zero values in the combination of the reconstructed transmitted signals. The flow of the method 600 now proceeds to step 608.

At step 608, the method 600 comprises cancelling the interference on the one or more WCBs that form a part of the received wireless signal in each q^{th} iteration. The interference is caused by corresponding one or more CCBs which form a part of the received wireless signal. The flow of the method 600 now proceeds to step 610.

At step 610, the method 400 comprises performing, by the channel equalization technique using the corresponding channel matrix, the channel equalization on interference free received wireless signals to form the one or more CCBs from the one or more WCBs identified in earlier iteration. The flow of the method 600 now proceeds to step 612.

At step 612, the method 600 comprises decoupling the channel equalized wireless signals to identify received wireless signals from each of the plurality of user equipment. The flow of the method 600 now proceeds to step 614.

Further, at step 614, the method 600 comprises demodulating the decoupled wireless signals from each of the plurality of user equipment to extract signal information of the one or more WCBs identified in the previous iteration. The channel equalized one or more CCBs relates to a part of the transmitted signals from each of the plurality of user equipment. The flow of the method 600 now proceeds to step 616.

At step 616, the method 600 comprises decoding, by the LDPC decoder for each of the plurality of user equipment, each bit of the demodulated wireless signals of the one or more WCBs identified in the previous iteration. The flow of the method 600 now proceeds to step 618.

At step 618, the method 600 comprises identifying the one or more CCBs and the one or more WCBs from the decoded wireless signals received from each of the plurality of user equipment for subsequent iterations.

While the above-discussed steps in FIG. 6A are shown and described in a particular sequence, the steps may occur in variations to the sequence in accordance with various embodiments. Further, a detailed description related to the various steps of FIG. 6A is already covered in the description related to FIG. 5 and is omitted herein for the sake of brevity.

FIG. 6B illustrates a detailed flow chart of a method step 602 for identifying the one or more CCBs and the one or more WCBs by preprocessing the received wireless signals from the plurality of user equipment, in accordance with an embodiment of the present disclosure. As depicted in FIG. 6B, the method 602 includes a series of steps 602A through 602D for identifying the one or more CCBs and the one or more WCBs. The method step 602 for identifying the one or more CCBs and the one or more WCBs by preprocessing the received wireless signal is performed for the initial iteration only. The method 600 begins execution of operations at step 602A, as shown in FIG. 6B.

At step 602A, the method 602 comprises performing, by the channel equalization technique, the channel equalization on the received wireless signals to compensate distortion of transmitted signals that are being transmitted by the plurality of user equipment. The flow of method 602 now proceeds to step 602B.

At step 602B, the method 602 comprises decoupling the channel equalized received wireless signals to identify received wireless signals from each of the plurality of user equipment. The flow of method 602 now proceeds to step 602C.

At step 602C, the method 602 comprises demodulating the received wireless signals of each of the plurality of user equipment to extract original signal information of the transmitted signals. The flow of method 602 now proceeds to step 602D.

At step 602D, the method 602 comprises decoding, by the LDPC decoder, each bit of the demodulated wireless signals of each of the plurality of user equipment for determining code blocks of the transmitted signals. The flow of method 602 now proceeds to step 602E.

At step 602E, the method 602 comprises identifying the one or more CCBs and the one or more WCBs from the determined code blocks of each of the plurality of user equipment.

While the above-discussed steps in FIG. 6B are shown and described in a particular sequence, the steps may occur in variations to the sequence in accordance with various embodiments. Further, a detailed description related to the various steps of FIG. 6B is already covered in the description related to FIGS. 5-6A and is omitted herein for the sake of brevity.

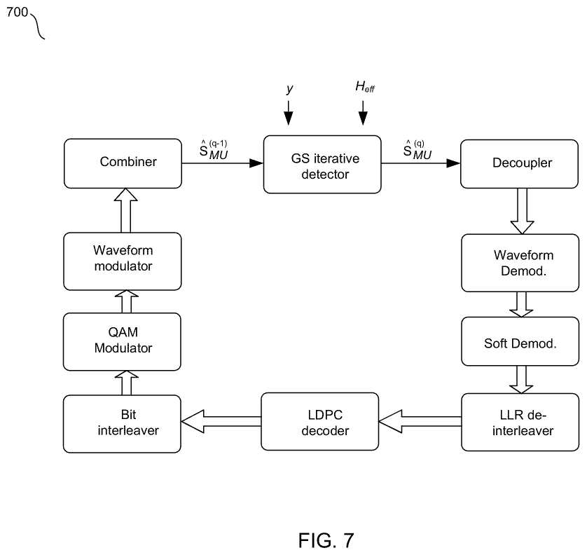

FIG. 7 illustrates a schematic circuit diagram of a turbo receiver for receiving wireless signals from the plurality of user equipment, in accordance with an embodiment of the present disclosure.

As shown in FIG. 7, the turbo receiver 700 decodes the received signal similar to the FEC-based SIC receiver 300, where the turbo receiver 700 performs an interference cancellation in each of its q^{th} iteration. The turbo receiver 700 receives wireless signals from the plurality of user equipment, i.e., from the multi-user. However, the turbo receiver 700 utilizes both the CCBs as well as the WCBs in the reconstruction of the transmitted signal. Further, the turbo receiver 700 uses a Gauss Seidel iterative detector, in the place of the MMSE in the FEC-based SIC receiver 300. The turbo receiver 700 supports processing received signals from multiple users. The received signal for the multiple transmissions in the uplink signals is similar to equation (5) of the present disclosure.

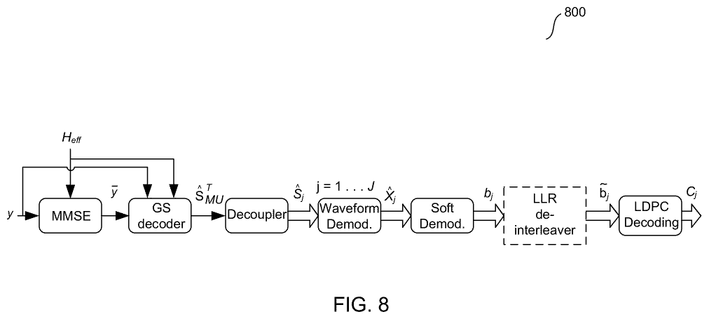

FIG. 8 illustrates a flow chart of preprocessing of the received wireless signal in the FEC-based SIC receiver 500 and the turbo receiver 700 used for multiple-user scenarios, in accordance with an embodiment of the present disclosure. According to one or more embodiments, the first iteration of signal processing is shown in form of a block diagram in FIG. 8. The purpose of the first iteration of signal processing is to identify the one or more CCBs and the one or more WCBs to initiate iterations of the SIC or turbo receivers.

As shown in FIG. 8, the flow chart 800 discloses the first iteration of signal processing for multi-user scenario in the FEC-based SIC receiver 500 and the turbo receiver 700. In the first iteration, the FEC-based SIC receiver 500 and the turbo receiver 700 (hereinafter both receivers are referred to as “multi-user receiver”) receive signal y. Thereby, the multi-user receiver decouples the received signal to determine signal received from j^{th} user among the multiple users. Further, the multi-user receiver demodulates and performs LDPC decoding to determine CCBs.

In a non-limiting example, Table 1 illustrates simulation parameters for evaluations of present disclosure. The following waveforms are considered for experiment of the present disclosure: OTFS, Orthogonal Time Sequency Multiplexing (OTSM), and Block based Single Carrier (Block SC).

TABLE 1

| | |
|---|---|
| Carrier frequency | 4 GHz |
| M × N | 612 × 128 |
| Δf | 15 kHz |
| Modulation | 16-QAM |
| FEC | LDPC [9] |
| Code rate | ½ |
| Code block length (Cₗ) | 648 |
| Max No. of decoding iterations | 50 |
| Channel | EVA [10] |
| delay spread | 2.51 μs |
| l_{maz} | 19 |
| Velocity | 120 kmph |
| Max. No. of GS iterations (U) | 2 |
| Max No. of SIC/Turbo iterations | 10 |
| (Q) | |

Using the parameters mentioned in Table 1, the LDPC FEC coded performance of the receivers is quantified in terms of Block Error Rate (BLER). The BLER is a ratio of the total number of CBs in error for all users to the total number of CBs transmitted by all users as L_{w}/L, where L_{w} corresponds to the total number of CBs in error and L corresponds to the total number of CBs transmitted by all users.

Doppler frequency for each path of an Extended Vehicular A (EVA) channel was generated using Jakes model, which may be defined as equation (7):

$${v}_{P} = {v}_{max} cos {θ}_{P} \qquad ( 7 )$$

where θₚ is uniformly distributed between [−π π] and νₘₐₓ is a maximum Doppler shift. The delays for allocation are equally shared among users and the allocated delay indices are adjacent.

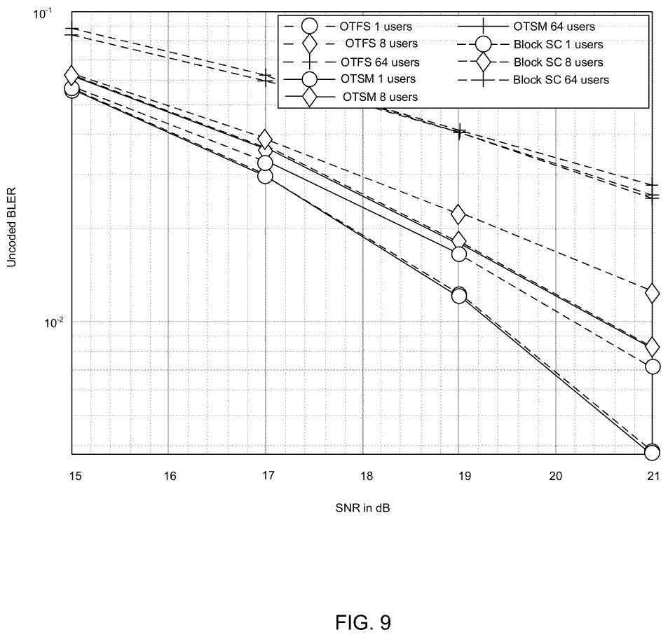

FIG. 9 illustrates a graphical representation of uncoded BLER performance of various waveforms for different numbers of users, in accordance with an embodiment of the present disclosure.

As shown in FIG. 9, the graph represents the uncoded BLER performance for OTFS, the OTSM waveform, and a Block Single-Carrier (SC) waveform for 1 user, 8 users, and 64 users. The uncoded BER for OTFS, OTSM, and block SC is computed by hard thresholding the Log Likely hood Ratio (LLR) values b˜ⱼ before the LDPC decoding in the first iteration of signal processing, prior to the SIC or turbo iterations begin. Thus, the uncoded BER performance is degrading with increasing users as depicted in FIG. 9.

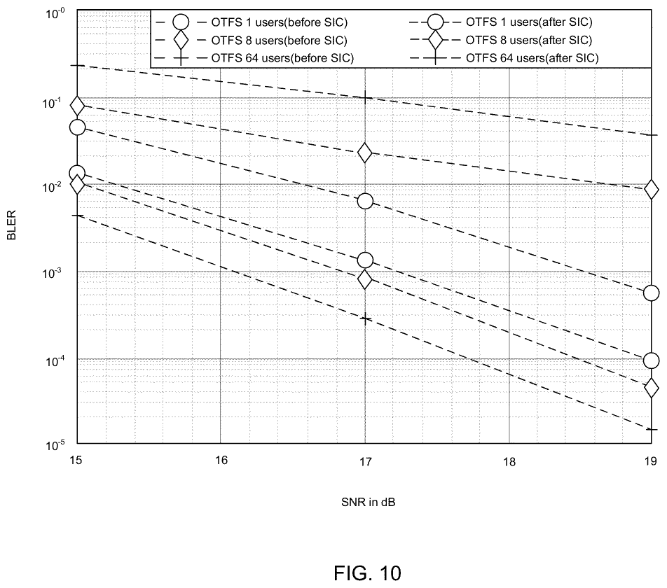

FIG. 10 illustrates a graphical representation of coded BLER performance of OTFS waveform with the FEC-based SIC receiver 500, in accordance with an embodiment of the present disclosure.

As shown in FIG. 10, the graph discloses the BLER performance of the OTFS waveform for 1 user, 8 users, and 64 users for the FEC-based SIC receiver 500 used for the plurality of user equipment. The graph also depicts BLER performance without SIC receiver (i.e., before using SIC receiver). As illustrated in FIG. 10, the BLER performance is improved significantly after including SIC receiver, i.e., by using the FEC-based SIC receiver 500 in comparison without using the SIC receiver. Therefore, by using the FEC-based SIC receiver 500, a gain of 4 dB is achieved for the operation for BLER of 10⁻² for an 8-user scenario.

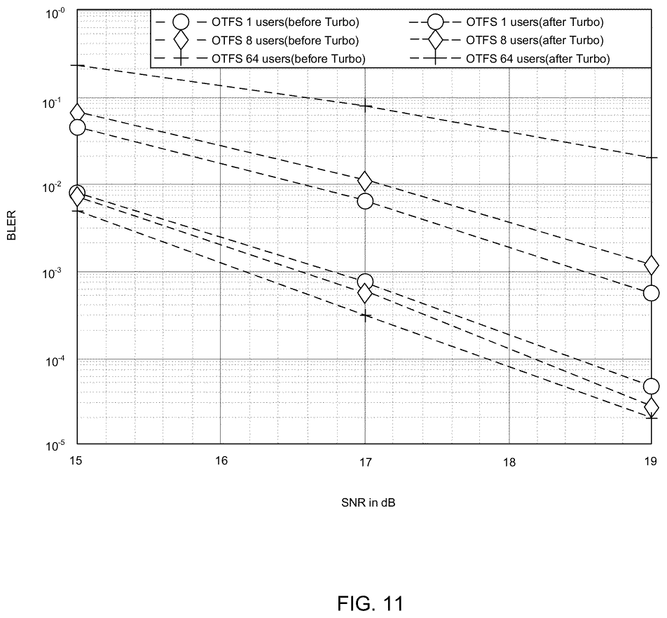

FIG. 11 illustrates a graphical representation of coded BLER performance of OTFS waveform for the turbo receiver 700, in accordance with an embodiment of the present disclosure.

As shown in FIG. 11, the graph discloses the BLER performance of the OTFS waveform for 1 user, 8 users, and 64 users for the turbo receiver 700 used for multiple users. The graph also depicts BLER performance without turbo receiver (i.e., before using turbo receiver). As illustrated in FIG. 11, the BLER performance is improved significantly after including the turbo receiver, i.e., by using the turbo receiver 700 in comparison without using the turbo receiver. By using the turbo receiver 700, a gain of 2 dB is achieved for BLER of 10⁻² for 8 user scenario.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiment will be apparent to those skilled in the art.

### Advantages of the Present Disclosure

The present disclosure relates to a method and receiver for interference cancellation-based reception for receiving wireless signals from the user equipment and from the plurality of user equipment. Particularly, the method and receiver interference cancellation-based reception are disclosed for single user and multi-user scenarios. The FEC-based SIC receiver updates corresponding channel matrix H^{(q)} and corresponding effective channel matrix H_{eff}^{(q)} in each of q^{th} iteration to improve performance of the receiver for both single and multi-user scenarios. Further, the method cancels multi-user interference in each SIC iteration. The SIC receiver also cancels intra-user interference caused by inter-symbol interference due to delay spread and/or Doppler spread of the wireless channel and improves individual user error performance as well as aggregated multi-user error performance. Further, the disclosed SIC operation, along with the channel update mechanism, is applicable in any domain of signal processing, including time domain, frequency domain, delay-Doppler domain, time-frequency domain, and space-time domain. Further, the complexity of channel equalization decreases as the SIC iterations progress.

In the detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The description is, therefore, not to be taken in a limiting sense.

We claim:

1. A method (400) for interference cancellation in wireless signal received from a user equipment, the method (400) comprising:
identifying (402) one or more Correctly decoded Code Blocks (CCBs) and one or more Wrongly decoded Code Blocks (WCBs) by preprocessing the received wireless signal;
reconstructing (404), by Quadrature Amplitude Modulation (QAM) followed by a waveform modulation, transmitted signal in each iteration based on the one or more CCBs identified from the received wireless signal up to previous iteration, wherein zero values are assigned to corresponding positions of the one or more WCBs;
determining (406), using an initial channel matrix (H), a corresponding channel matrix (H^{(q)}) in each iteration based on the positions of zero or non-zero values in the reconstructed transmitted signals (s˜^{(q)};
cancelling (408) the interference in each iteration on the one or more WCBs that form a part of the received wireless signal, wherein the interference is caused by corresponding one or more CCBs which form a part of the received wireless signal; and
performing (410), by a channel equalization technique using the corresponding channel matrix (H^{(q)}), a channel equalization on interference free received wireless signal to form the one or more CCBs from the one or more WCBs identified in earlier iteration.

2. The method (400) as claimed in claim 1 further comprises:
demodulating (412) the channel equalized wireless signals to extract signal information of the one or more WCBs identified in the previous iteration;
decoding (414), by a Low-Density Parity-Check (LDPC) decoder, each bit of the demodulated wireless signals of the one or more WCBs identified in the previous iteration; and
identifying (416) the one or more CCBs and the one or more WCBs from the decoded wireless signals for subsequent iterations.

3. The method (400) as claimed in claim 1, wherein the one or more CCBs and the one or more WCBs are identified (402) by preprocessing the received wireless signal for an initial iteration only, the method (400) of preprocessing further comprises the steps of:
performing (402A), by the channel equalization technique, the channel equalization on the received wireless signal to compensate distortion of the transmitted signals that are being transmitted by the user equipment;
demodulating (402B) the channel equalized wireless signals to extract original signal information of the transmitted signals;
decoding (402C), by a Low-Density Parity-Check (LDPC) decoder, each bit of the demodulated wireless signals for determining code blocks of the transmitted signals; and
identifying (402D) the one or more CCBs and the one or more WCBs from the determined code blocks.

4. The method (400) as claimed in claim 2, wherein demodulating the channel equalized wireless signals further comprises:
performing a waveform demodulation on the channel equalized wireless signal;
estimating Log Likelihood Ratio (LLR) values of the demodulated received wireless signal by a soft demodulation; and
forming, based on the estimated LLR values, code blocks for LDPC decoding by the LDPC decoder.

5. The method (400) as claimed in claim 3, wherein the one or more CCBs and the one or more WCBS are identified using a Cyclic Redundancy Check (CRC) process after the LDPC decoding.

6. The method (400) as claimed in claim 1, wherein cancelling the interference on the one or more WCBs further comprising:
reconstructing originally transmitted signal using the CCBs identified from the received wireless signal up to the previous iteration, wherein zeros are assigned to corresponding positions of the modulation symbols of the WCBs;
processing the reconstructed transmitted signal by multiplying the initial channel matrix with the reconstructed transmitted signals; and
subtracting the processed reconstructed transmitted signals from the received wireless signal to cancel the interference on the one or more WCBs.

7. The method (400) as claimed in claim 1, wherein
the corresponding channel matrix is updated in each iteration based on the zero or non-zero values in the reconstructed transmitted signals, and
the corresponding channel matrix is updated by nullifying column vectors of the corresponding channel matrix using zero vectors relating to indices of the non-zero values in the reconstructed wireless signals, wherein the non-zero values exist over corresponding positions of the one or more CCBs in the reconstructed transmitted signals.

8. The method (400) as claimed in claim 1, wherein the identification of the one or more CCBs and the one or more WCBs is continued until:
a threshold number of iterations is reached, or
all code blocks of the received wireless signal relates to the one or more CCBs, or no new CCBs are obtained in a present iteration.

9. A method (600) for cancelling interference in received wireless signals from a plurality of user equipment, the method (600) comprising:
Identifying (602), by preprocessing the received wireless signals, one or more Correctly decoded Code Blocks (CCBs) and one or more Wrongly decoded Coded Blocks (WCBs) in the wireless signals received from each of the plurality of user equipment;
reconstructing (604), by Quadrature Amplitude Modulation (QAM) followed by a waveform modulation in each iteration, transmitted signals from the plurality of user equipment by combining the one or more CCBs identified from the received wireless signal up to previous iteration from each of the plurality of user equipment, wherein zero values are assigned to corresponding positions of the one or more WCBs;
determining (606), using an initial effective channel matrix, a corresponding effective channel matrix in each iteration based on the positions of zero or non-zero values in the combination of the reconstructed transmitted signals;
cancelling (608) the interference on the one or more WCBs that form a part of the received wireless signal in each iteration, wherein the interference is caused by corresponding one or more CCBs which form a part of the received wireless signal; and
performing (610), by a channel equalization technique using the corresponding channel matrix, a channel equalization on interference free received wireless signals to form the one or more CCBs from the one or more WCBs identified in earlier iteration.

10. The method (600) as claimed in claim 9 further comprises:
decoupling (612) the channel equalized wireless signals to identify received wireless signals from each of the plurality of user equipment;
demodulating (614) the decoupled wireless signals from each of the plurality of user equipment to extract signal information of the one or more WCBs identified in the previous iteration, wherein the channel equalized one or more CCBs relates to a part of the transmitted signals from each of the plurality of user equipment;
decoding (616), by a Low-Density Parity-Check (LDPC) decoder for each of the plurality of user equipment, each bit of the demodulated wireless signals of the one or more WCBs identified in the previous iteration; and
identifying (618) the one or more CCBs and the one or more WCBs from the decoded wireless signals received from each of the plurality of user equipment for subsequent iterations.

11. The method (600) as claimed in claim 9, wherein the one or more CCBs and the one or more WCBs further are identified (602) by preprocessing the received wireless signals from the plurality of user equipment for an initial iteration only, the method of preprocessing further comprises the steps of:
performing (602A), by the channel equalization technique, the channel equalization on the received wireless signals to compensate distortion of transmitted signals that are being transmitted by the plurality of user equipment;
decoupling (602B) the channel equalized received wireless signals to identify received wireless signals from each of the plurality of user equipment;
demodulating (602C) the received wireless signals of each of the plurality of user equipment to extract original signal information of the transmitted signals;
decoding (602D), by a Low-Density Parity-Check (LDPC) decoder, each bit of the demodulated wireless signals of each of the plurality of user equipment for determining code blocks of the transmitted signals; and
identifying (602E) the one or more CCBs and the one or more WCBs from the determined code blocks of each of the plurality of user equipment.

12. The method (600) as claimed in claim 10, wherein demodulating the received wireless signals of each of the plurality of user equipment further comprises:
performing a waveform demodulation on the received wireless signals of each of the plurality of user equipment;
estimating, by a soft demodulation, Log Likelihood Ratio (LLR) values of the demodulated received wireless signals of each of the plurality of user equipment; and
forming, based on the estimated LLR values, code blocks for LDPC decoding by the LDPC decoder.

13. The method (600) as claimed in claim 9, wherein
the corresponding effective channel matrix is updated in each iteration based on the zero or non-zero values in the reconstructed transmitted signals from the plurality of user equipment, and
the corresponding effective channel matrix is updated by nullifying column vectors of the corresponding channel matrix using zero vectors relating to indices of the non-zero values in the reconstructed wireless signals from the plurality of user equipment, wherein the non-zero values exist over corresponding positions of the one or more CCBs in the reconstructed transmitted signals.

14. An apparatus of Forward Error Correction (FEC) based Successive Interference Cancellation (SIC) receiver (300) for cancelling interference in wireless signal received from a user equipment, the apparatus comprising:
one or more antennas (322) configured for receiving analog wireless signal from a transmitter of the user equipment;
an analog-to-digital converter (ADC) device (324) for converting analog wireless signals to corresponding digital signals;
at least one processor (320) communicatively coupled with the one or more antennas (322) and the ADC device (324), the at least one processor (320) is configured to:
identify one or more Correctly decoded Code Blocks (CCBs) and one or more Wrongly decoded Code Blocks (WCBs) by preprocessing the digital signals of the received wireless signal;
reconstruct, by Quadrature Amplitude Modulation (QAM) followed by a waveform modulation, transmitted signal in each iteration based on the one or more CCBs identified from the received wireless signal up to previous iteration, wherein zero values are assigned to corresponding positions of the one or more WCBs;
determine, using an initial channel matrix, a corresponding channel matrix in each iteration based on the positions of zero or non-zero values in the reconstructed transmitted signals;
cancel the interference in each iteration on the one or more WCBs that form a part of the received wireless signal, wherein the interference is caused by corresponding one or more CCBs which form a part of the received wireless signal; and
perform, by a channel equalization technique using the corresponding channel matrix, a channel equalization on interference free received wireless signal to form the one or more CCBs from the one or more WCBs identified in earlier iteration.

15. An apparatus of Forward Error Correction (FEC) based Successive Interference Cancellation (SIC) receiver (500) for cancelling interference in wireless signals received from a plurality of user equipment, the apparatus comprising:
one or more antennas (522) configured for receiving analog wireless signal from one or more transmitters corresponding to the plurality of user equipment;
a plurality of analog-to-digital converter (ADC) devices (524) for converting analog wireless signals to corresponding digital signals;
at least one processor (520) communicatively coupled with the one or more antennas (522) and the plurality of ADC devices (524), the one or more processors (520) are configured to:
identify, by preprocessing the received wireless signals, one or more Correctly decoded Code Blocks (CCBs) and one or more Wrongly decoded Coded Blocks (WCBs) in the wireless signals received from each of the plurality of user equipment;
reconstruct, by Quadrature Amplitude Modulation (QAM) followed by a waveform modulation in each iteration, transmitted signals from the plurality of user equipment by combining the one or more CCBs identified from the received wireless signal up to previous iteration from each of the plurality of user equipment, wherein zero values are assigned to corresponding positions of the one or more WCBs;
determine, using an initial effective channel matrix, a corresponding effective channel matrix in each iteration based on the positions of zero or non-zero values in the combination of the reconstructed transmitted signals;
cancel the interference on the one or more WCBs that form a part of the received wireless signal in each iteration, wherein the interference is caused by corresponding one or more CCBs which form a part of the received wireless signal; and
perform, by a channel equalization technique using the corresponding channel matrix, a channel equalization on interference free received wireless signals to form the one or more CCBs from the one or more WCBs identified in earlier iteration.
